(19) United States
(12) Patent Application Publication
(10) Pub. No.: US 2024/0095689 A1
(43) Pub. Date: Mar. 21, 2024

(54) RECYCLING MANAGEMENT SYSTEM AND METHOD

(71) Applicant: SECURITY MATTERS LTD., D.N. Hevel Eilot (IL)

(72) Inventor: Haggai ALON, Kibbutz Naan (IL)

(21) Appl. No.: 18/263,761

(22) PCT Filed: Jan. 31, 2022
(86) PCT No.: PCT/IL2022/050133

§ 371 Date: Aug. 1, 2023

Related U.S. Application Data
(60) Provisional application No. 63/144,546, filed on Feb. 2, 2021.

(51) Int. Cl. G06Q 10/30; G06Q 30/018

(52) U.S. Cl. CPC G06Q 10/30; G06Q 30/018

(57) ABSTRACT

There is provided a technique of managing units of plastic material in a cycle involving a plurality of producers and a plurality of recyclers, each given unit bearing a mark with extractable mark-informative data associated with the given unit and informative of one or more properties thereof. The technique comprises for each recycler: using mark-informative data associated with the units of plastic material to track an amount and quality of plastic material recycled thereby; allocating one or more new Plastic Tokens in accordance with the amount of the recycled plastic material and tracking a number of Plastic Tokens allocated thereto. For each producer: using mark-informative data associated with the units of plastic material to track an amount of virgin plastic used thereby; tracking a number of Plastic Tokens allocated thereto and reducing the number of allocated Plastic Tokens in accordance with the amount of used virgin plastic material. The technique further comprises enabling converting the allocated Plastic Tokens into the Plastic Credits, each Plastic Credit associated with a certain recycler or producer, wherein a Plastic Token is a digital certificate representative of rights to use in production a certain amount of virgin plastic material and wherein a Plastic Credit is a Plastic Token associated with a monetized value thereof.

### TECHNOLOGICAL FIELD

The presently disclosed subject matter relates to the field of managing recyclable products and, more particularly, to managing recyclable products with the help of delegated proof-of-stake consensus techniques.

### BACKGROUND

Growing global interest in the welfare of the environment demands minimizing the use of virgin materials and recycling the wastes. Many products are capable of being recycled including electronic products, glass, paper, metal, plastic and so on. Such products are referred to hereinafter as “recyclable products”. Recycling is an important aspect of natural resource management and sustainability. A circular recycling economy, implemented in recent years, expands the life cycle of the recyclable products via recycling, redistributing and/or re-manufacturing loops along a respective chain-of-supply.

Among significant challenges of the circular recycling economy is recycling of plastic products. Experts estimate that demand for plastics has increased twentyfold in the past 50 years and that it will double again in the next 20 years. The variety of different types of plastic increases the recycling problems since the recycling processes (chemical or mechanical), in many cases, are designed according to the specific polymeric materials.

Effective recycling economy requires recycling management along a chain-of-supply, including marking, identifying and tracing the recyclable materials. The problems of recycling management in general and managing plastic recycling, in particular, have been recognized in the conventional art and various systems have been developed to provide a solution, for example:

US Patent Publication No. US2022/0005002 discloses a technique of a closed loop process for collecting and recycling of materials commonly used for packaging. The process comprises the steps of collecting and sorting of items containing material to be recycled, creating one or more datasets relating to the portions of sorted materials containing information relating to the quantity and origin as well as identity, brand, type and/or quality of sorted material, and registering at least the quantity and origin and optionally also about identity, brand, type and/or quality of sorted material in a blockchain. Embodiments of the invention comprise performing software assisted item recognition for determining at least one property of an item.

International Patent Publication No. WO21/070182 discloses techniques for monitoring production and reuse of a recyclable material, and/or determining a currency or quality measure thereof. One or more markers are introduced into ingredient material components of the recyclable material, where the one or more markers being indicative of one or more properties of at least one of the ingredient material components. Information indicative of at least the one or more properties is recorded in a database comprising a plurality of records, each associated with at least one of the one or more markers. A signal obtained from a product comprising the recyclable material is processed for determining presence of at least one of the one or more markers and based thereon the information recorded in at least one of the database records associated therewith, and a quality or currency measure of at least one of the ingredient material components of the recyclable material comprised in the product is determined based on the one or more properties indicative by the information.

US Patent Publication No. US2021/0012278 discloses a method of managing transactions of physical objects and a system thereof. The system is connectable to a first distributed ledger adapted to record object transactions associated with transactions of one or more physical objects between parties. The system includes a second distributed ledger adapted to record data indicative of object handling operations carried out with respect to the one or more physical objects; and an object handling management module adapted to authenticate handling operations carried out with respect to the one or more physical objects. The object handling management module is configured and operable for obtaining parameters of execution of the handling operations, authenticating the parameters of execution of the handling operations, and recording the authenticated handling operations in the second distributed ledger. The system thereby enables recordation of the object transactions associated with the one or more physical objects upon authenticating that the parameters of execution of the handling operations that are carried out with respect to the one or more physical objects satisfy one or more respective predetermined conditions.

US Patent Publication No. US2020/0184465 discloses system and method for virtual currency based on blockchain architecture and physical marking. In an embodiment, a method for recording a marked object includes: determining specific and unique marking of the object by a reader unit; and communicating encrypted data indicative of the marking and data indicative of the marked object to at least one server system, for generating at least one record of the object and its marking thereat. The at least one server system may be a distributed blockchain system including: at least one blockchain service module adapted for recording transactions of objects in a blockchain; and at least one management service module adapted for authorization of each transaction of an object based on authentication of the transaction by: providing a reader unit with a certain reading scheme/parameters that authorize/enable the reader unit to correctly read the specific marking on the object; and obtaining from the reader unit in response, a reading data indicative of the marking being read using the reading scheme, and authenticating the object based on a match between the reading data and stored data of the object's marking which is stored by the at least one server. In turn, before carrying out a request for recordation of a transaction for the object in the blockchain, the blockchain service module is adapted to await authorization of the transaction from the management service.

US Patent Publication No. US2020/0143336 discloses systems and methods for a circular waste economy platform consisting of waste sellers, waste buyers, and waste transport providers, where the platform utilizes artificial intelligence to facilitate the sale, transfer, and fulfillment of waste between sellers and buyers, and where the waste transactions are recorded on a distributed ledger.

The references cited in the background teach many principles of managing electronic documents associated with physical objects, some of such principles can be applicable to the presently disclosed subject matter. Therefore, the full contents of these publications are incorporated by reference herein where appropriate for appropriate teachings of additional or alternative details, features and/or technical background.

### GENERAL DESCRIPTION

In accordance with certain aspects of the presently disclosed subject matter, there is provided a method of managing units of plastic material in a cycle involving a plurality of producers and a plurality of recyclers, each given unit bearing a mark with extractable mark-informative data associated with the given unit and informative of one or more properties thereof.

The method comprises: using mark-informative data associated with the units of plastic material to track an amount and quality of plastic material recycled by each recycler of the plurality of recyclers; for each recycler, allocating one or more new Plastic Tokens in accordance, at least, with the amount of the plastic material recycled thereby and tracking a number of Plastic Tokens allocated thereto, wherein a quantity of new Plastic Tokens allocated for a certain amount of recycled plastic material is defined by a preconfigured “allocation conversion rate”. The method further comprises: using mark-informative data associated with the units of plastic material to track an amount of virgin plastic used by each producer of the plurality of the producers; for each producer, tracking a number of Plastic Tokens allocated thereto and reducing the number of allocated Plastic Tokens in accordance, at least, with the amount of virgin plastic material used thereby, wherein a quantity of Plastic Tokens reduced due to using a certain amount of virgin plastic material is defined by a preconfigured “reduction conversion rate”; and enabling converting the allocated Plastic Tokens into the Plastic Credits, each Plastic Credit associated with a certain recycler or producer, wherein a Plastic Token is a digital certificate representative of rights to use in production a certain amount of virgin plastic material and wherein a Plastic Credit is a Plastic Token associated with a monetized value thereof.

One or more recyclers from the plurality of recyclers and one or more producers from the plurality of producers can be enabled to trade the Plastic Credits therebetween and, optionally, to further convert the Plastic Credits into the Plastic Tokens.

Optionally, all events of allocating or reducing the Plastic Tokens can be recorded in one or more blockchains, wherein a record of an allocating or reducing event is informative of a respective producer and/or recycler, timestamp of the event and a number of Plastic Tokens allocated or reduced in connection with the event.

In accordance with further aspects and, optionally, in combination with other aspects of the presently disclosed subject matter, the method further comprises: using mark-informative data associated with units of plastic material recycled by a given recycler to record events of transferring ownership of the recycled material thereby to yield one or more records of first TOO events, wherein each record is informative, at least, of time of a respective 1st TOO event, amount of the recycled plastic material and of a new owner or a decommission; using the one or more records of 1st TOO events to track an amount of plastic material recycled by the given recycler during a first time interval; and allocating to the given recycler one or more Plastic Tokens based on amount of the plastic material recycled during the first time interval and recording an event of allocating the one or more Plastic Tokens to the given recycler.

The one or more records of 1st TOO events can be further informative of quality of respective recycled plastic material, and can be further used for tracking quality of plastic material recycled by the given recycler during the first time interval and for respective allocating the one or more Plastic Tokens.

In accordance with further aspects and, optionally, in combination with other aspects of the presently disclosed subject matter, the method can further comprise: upon receiving by the given recycler one or more units of plastic material, using the mark-informative data associated with the received one or more units to authorize the given recycler as a current owner and to track the received one or more units of plastic material until one or more 1st TOO events related thereto.

In accordance with further aspects and, optionally, in combination with other aspects of the presently disclosed subject matter, the method further comprises: using mark-informative data associated with one or more units of virgin plastic material used by a given producer of plastic products to record one or more events of transferring ownership of produced plastic products, thereby yield one or more records of second TOO events, wherein each record is informative, at least, of the time of event, amount of the used virgin plastic material and the new owner; using the one or more records of 2nd TOO events to track amount of virgin plastic material used by the given producer during a second time interval; and reducing the number of Plastic Tokens allocated to the given producer, the reduction based on the amount of virgin plastic material used by the given producer during the second time interval in the products with transferred ownership, and recording an event of reducing the one or more Plastic Tokens to the given producer.

The one or more records of 2nd TOO events can be further informative of quality of respective virgin plastic material, and can be further used for tracking quality of virgin plastic material used by the given producer during a second time interval and respective reduction of the one or more Plastic Tokens.

In accordance with further aspects and, optionally, in combination with other aspects of the presently disclosed subject matter, the method can further comprise: upon receiving by the given producer one or more units of virgin plastic material, using mark-informative data associated with the one or more units of virgin plastic material to authorize the given producer as a current owner and to track the virgin plastic material until one or more 2nd TOO events related thereto.

In accordance with further aspects and, optionally, in combination with other aspects of the presently disclosed subject matter, the method can further comprise: using the one or more records of 2nd TOO events to track amount of recycled plastic material used by the given producer during a third time interval; and allocating to the given producer one or more Plastic Tokens for using recycled plastic materials based on amount of the recycled plastic material used during the third time interval and recording an event of allocating the one or more Plastic Tokens to the given producer.

The records of 1^{st} TOO event and 2^{nd} TOO events can be recorded in one or more blockchains.

In accordance with other aspects of the presently disclosed subject matter, there is provided a system configured to manage units of plastic material in a cycle involving a plurality of producers and a plurality of recyclers, each given unit bearing a mark with extractable mark-informative data associated with the given unit and informative of one or more properties thereof, the system configured to operate in accordance with the method detailed with reference to the above aspects.

In accordance with other aspects of the presently disclosed subject matter, there is provided one or more computing devices comprising processors and memory, the one or more computing devices configured, via computer-executable instructions, to perform operations for operating, in a cloud computing environment, a system capable of managing units of plastic material in a cycle involving a plurality of producers and a plurality of recyclers, each given unit bearing a mark with extractable mark-informative data associated with the given unit and informative of one or more properties thereof. The operations comprising: using mark-informative data associated with the units of plastic material to track an amount and quality of plastic material recycled by each recycler of the plurality of recyclers; for each recycler, allocating one or more new Plastic Tokens in accordance, at least, with the amount of the plastic material recycled thereby and tracking a number of Plastic Tokens allocated thereto, wherein a quantity of new Plastic Tokens allocated for a certain amount of recycled plastic material is defined by a preconfigured “allocation conversion rate”; using mark-informative data associated with the units of plastic material to track an amount of virgin plastic used by each producer of the plurality of the producers; for each producer, tracking a number of Plastic Tokens allocated thereto and reducing the number of allocated Plastic Tokens in accordance, at least, with the amount of virgin plastic material used thereby, wherein a quantity of Plastic Tokens reduced due to using a certain amount of virgin plastic material is defined by a preconfigured “reduction conversion rate”; and enabling converting the allocated Plastic Tokens into the Plastic Credits, each Plastic Credit associated with a certain recycler or producer, wherein a Plastic Token is a digital certificate representative of rights to use in production a certain amount of virgin plastic material and wherein a Plastic Credit is a Plastic Token associated with a monetized value thereof.

In accordance with other aspects of the presently disclosed subject matter, there is provided a non-transitory computer-readable medium comprising instructions that, when executed by a computing system comprising a memory storing a plurality of program components executable by the computing system, cause the computing system to operate in accordance with the method detailed with reference to the above aspects.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates a generalized recycling environment including a computerized Exchange Platform (EXP) configured in accordance with certain embodiments of the presently disclosed subject matter;

FIG. 2 illustrates a non-limiting schematic example of data exchange between the players in the chain-of-supply and EXP 105 configured in accordance with certain embodiments of the presently disclosed subject matter;

FIG. 3 illustrates a generalized flow-chart of managing recyclable materials in accordance with certain embodiment of the presently disclosed subject matter;

FIG. 4 illustrates a generalized flow-chart of recycling stream of managing recyclable materials in accordance with certain embodiment of the presently disclosed subject matter;

FIG. 5 illustrates a generalized flow-chart of producing stream of managing recyclable materials in accordance with certain embodiment of the presently disclosed subject matter; and

FIG. 6 illustrates a generalized block diagram of EXP 105 configured in accordance with certain embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “recording”, “tracking”, “allocating”, “reducing” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the computerized exchange platform (EXP) disclosed in the present application.

The operations in accordance with the teachings herein may be performed by a computer specially constructed for the desired purposes or by a general-purpose computer specially configured for the desired purpose by a computer program stored in a non-transitory computer-readable storage medium.

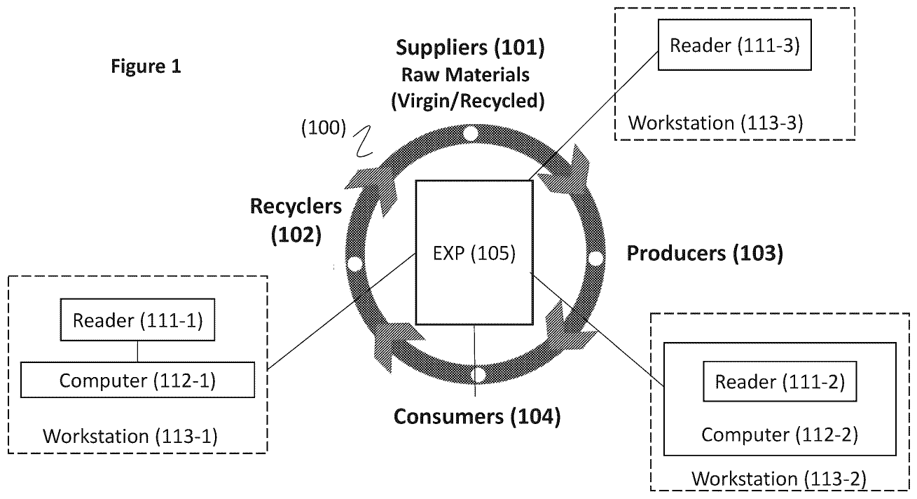

Bearing this in mind, attention is drawn to FIG. 1 illustrating a generalized recycling environment including a computerized Exchange Platform (EXP) configured in accordance with certain embodiments of the presently disclosed subject matter.

For purpose of illustration only, the following description is provided for recycling of plastic products. Those skilled in the art will readily appreciate that the teachings of the presently disclosed subject matter are, likewise, applicable to recycling of other recyclable products.

The generalized plastic recycling environment includes a supply chain 100 (referred to hereinafter also as “chain-of-supply” or “chain”) with a plurality of players including suppliers 101 of virgin and recycled raw materials, recyclers 102, producers 103 and consumers 104. In accordance with certain embodiments of the presently disclosed subject matter, the players can be registered at a computerized exchange platform 105 (EXP). Each registered player can be associated with a computerized workstation that is configured to operate in data communication with EXP 105.

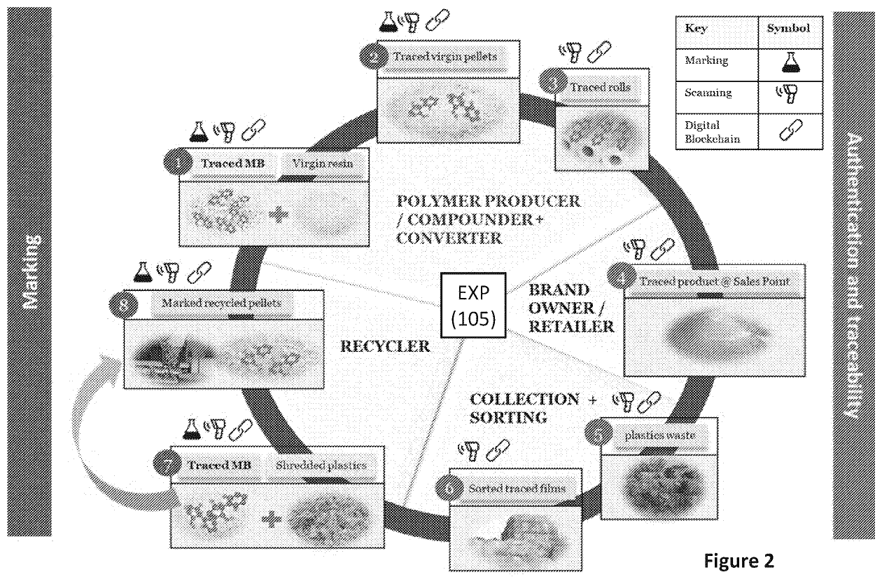

As will be further detailed with reference to FIGS. 2-6, EXP 105 is configured to enable digital exchange (including digital trade) of digital certificates between different parties across the chain. In the following description, a digital certificate representative of rights to use in production a unit with a predefined amount of virgin plastic material is referred to hereinafter as a “Plastic Token” and a Plastic Token associated with a monetized value is referred to hereinafter as “Plastic Credit”.

It is noted that each Plastic Token represents a right of use of the same amount of virgin plastic material of a certain type, this amount can differ for different types of virgin materials. The monetized value of a given Plastic Token can vary and can differ from a monetized value of another Plastic Token depending on conditions of trading the respective Plastic Credits.

EXP 105 enables the following recycling approach
Plastic Tokens are periodically allocated to the producers and/or the underlying industries;
Every use of virgin plastic material requires Plastic Token(s) and, thus reduces the number of Plastic Tokens available to a respective producer;
Recycling of plastic materials results in allocating Plastic Tokens to recyclers in accordance with predefined criteria;
Plastic Tokens are convertible in Plastic Credits and vise versa;
Plastic Credits are tradable on a primary market and on secondary markets;
A producer can purchase Plastic Credits and convert them into Plastic Tokens required for using of virgin plastic material in production.

Thus, EXP 105 enables generating and managing digital assets (Plastic Credits and Plastic Tokens) usable in producing and recycling streams of the chain-of supply.

It is noted that the term “plastic material” should be expansively construed to cover any kind, form, amount and combination of virgin and/or recycled plastics as well as plastics included in intermediate or final products. It is further noted that the term “unit of plastic material” refers to a certain quantity of plastic material (of any kind and form) measured in volume and/or weight. The volume/weight of a plastic material in a unit can vary in a predefined manner depending on the type and form (e.g. pellets, bottles, shredded bottles, etc.) and packaging.

As known in the conventional art, the plastic material can be marked, during its production, with taggant material constituting a mark informative of one or more properties of the plastic material. Data characterizing one or more properties of a plastic material and extractable from its marking are referred to hereinafter as mark-informative data associated with the plastic material.

In accordance with certain embodiments of the currently presented subject matter, the mark-informative data are informative at least of such properties as a manufacturer (a producer or a recycler) of a respective unit of plastic material and a plastic type therein. Optionally, the mark can be further informative of percentage of recycled plastic in the unit of plastic material, of a current recycling cycle, of a type of recycling, etc. In a case of plastic products comprising multiple types of plastic, the mark-informative data can be representative of each respective type (and optionally, relative percentage) of plastic therein.

A mark can be configured to emit an electromagnetic signal detectable by a suitable spectrometer (referred to hereinafter as a reader) and informative of represented by the mark properties of the plastic material. By way of non-limiting the marks can be configured to emit the electromagnetic signal in response to an electromagnetic radiation incoming from the reader (e.g. ultraviolet (UV), X-ray diffraction (XRD) or X-ray Fluorescence (XRF) marks). For example, the mark can be XR-responding taggant material embedded in the plastic material (e.g. X-Ray-Fluorescence (XRF) signatures identifiable via XRF analysis of the respective physical objects), and the reader can be configured to carry out X-ray spectroscopy to read said XR-responding marking (e.g. by illuminating at least parts of a plastic material with X-Rays of gamma-Rays and detecting X-Ray-Fluorescence response indicative of its properties).

As illustrated in FIG. 1, EXP 105 is operatively connected to a plurality of workstations 113-1-113-3, each workstation having at least one reader and is associated with a certain player. By way of non-limiting example, workstation 113-1 is associated with one of recyclers and comprises a reader 111-1 operatively connected to a computer 112-1; workstation 113-2 is associated with one of producers and comprises a computer 112-2 with a reader 111-2 integrated therein; and workstation 113-3 is associated with one of suppliers of raw materials and comprises a reader 111-3 operatively connected directly to EXP 105.

Upon receiving by a given player a marked unit of plastic material, a respectively associated reader obtains a signal from the mark. Further, the reader (and/or computer operatively connected thereto) extracts mark-informative data from the signal, thereby obtaining data informative of the unit's properties. The workstation further sends mark-informative data (and/or derivatives thereof) to the EXP 105 for authentication of, at least, the type of plastic and the manufacturer of the unit. As will be further detailed with reference to FIGS. 2-6, EXP 105 enables recording the authenticated data (and/or derivative thereof). EXP also enabled recording transfer-of-ownership (TOO) events when the unit of plastic material is transferred from one owner to another. Recording can be provided in one or more blockchains.

Authenticating identity of a unit can be provided by verifying the marking, i.e. determining a match between mark-informative data with pre-stored reference data informative of the unit. Likewise, authenticating identity of an entity in possession of a reader can be provided by verifying the marking, i.e. determining a match between the data identifying the reader and reference data listing respective entities that are in possession of the reader.

By way of non-limiting example, marking the units of plastic materials and further tracking thereof in the chain-of-supply can be provided in a manner detailed in International Patent Publications Nos. WO2018/207180, WO 2019/175878 and WO21074919, assigned to the assignee of the present application and incorporated herewith by reference.

Referring to FIG. 2, there is provided a non-limiting schematic example of data exchange between the players in the chain-of supply and EXP 105. As illustrated, different units of plastic material are marked during production/recycling. The units are moved along the chain-of-supply. It is noted, that decommission of units by one of the players is also considered hereinafter as moving such units along the chain.

Further, when a next player receives a unit, the unit is scanned with the help of the reader to extract mark-informative data associated with the unit. EXP 105 enables recording this data and/or derivatives (e.g. authentication results) thereof in one or more blockchains. EXP 105 also enables recording in the blockchain the respective TOO events of transferring ownership of the units of plastic material.

By way of non-limiting example, TOO events can be registered in a blockchain with the help of “smart contracts”. The term “smart contract” is referred to executable computer code or logic that can be executed according to an agreement between parties upon the occurrence of a condition precedent.

EXP 150 can implement smart contracts related to a change in ownership of a marked plastic material, such change is conditioned on verification that the marked plastic material is marked by a particular marking. For instance, a player receiving the ownership may wish to authenticate the received plastic material by checking whether the material carries a specific marking applied manufacturing. The TOO event can be considered as executed and recorded to the blockchain only when the respective marking is verified.

It is noted that the teachings of the presently disclosed subject matter are not bound by the recycling environment described with reference to FIG. 1 and FIG. 2. Equivalent and/or modified functionality can be consolidated or divided in another manner and can be implemented in any appropriate combination of software with firmware and/or hardware and executed on one or more suitable devices. At least part of the functionality of EXP 105 can be implemented in a cloud and/or distributed and/or virtualized computing arrangement. The chain-of supply can include more or less players than illustrated in FIG. 2.

It is also noted that for purpose of illustration only the description refers to recording data informative of certain events in one or more blockchains. Those skilled in the art will readily appreciate that the teachings of the presently disclosed subject matter are, likewise, applicable to recording event-informative data in any other structured distributed list(s) of data records with delegated “proof-of-stake” consensus (distributed ledger(s)) capabilities.

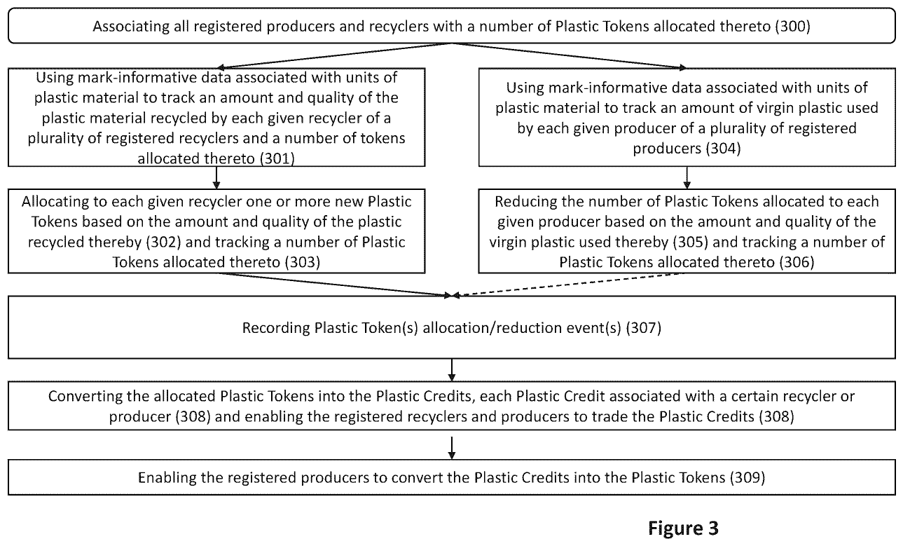

Referring to FIG. 3, there is illustrated a generalized flow-chart of managing recyclable materials in accordance with certain embodiment of the presently disclosed subject matter.

EXP 105 is configured to manage the records associating all registered producers and recyclers with a number of Plastic Tokens allocated thereto (300).

EXP 105 uses mark-informative data associated with the units of plastic material to track (301) an amount and quality of the plastic material recycled by each given recycler of a plurality of recyclers registered at EXP 105. To each given recycler, EXP 105 allocates (302) one or more new Plastic Tokens in accordance with the amount and, optionally, the quality of the plastic material recycled thereby. Quality of the recycled plastic material can be characterized by a type of plastic, type of recycling operation and technology and its place in the chain-of-supply, number of recycling operations, recycling cycle, etc. The number of Plastic Tokens allocated by EXP 105 for a certain amount of recycled plastic material is defined by a preconfigured “allocation conversion rate”, optionally varying for different quality of recycled plastic material. Optionally, the allocation conversion rate can further vary for different recyclers (for example, some recyclers can be provided with a temporal incentive rate). EXP 105 tracks (303) a number of Plastic Tokens allocated to each recycler.

Likewise, EXP 105 uses mark-informative data associated with the units of plastic material to track (304) an amount of virgin plastic used by each given producer. For each given producer, EXP 105 reduces (305) the number of Plastic Tokens allocated thereto in accordance with the amount and, optionally, type of virgin plastic material used thereby. The number of Plastic Tokens reduced by EXP 105 due to using a certain amount of virgin plastic material is defined by a preconfigured “reduction conversion rate”, optionally varying for different types of virgin plastic material and/or different producers.

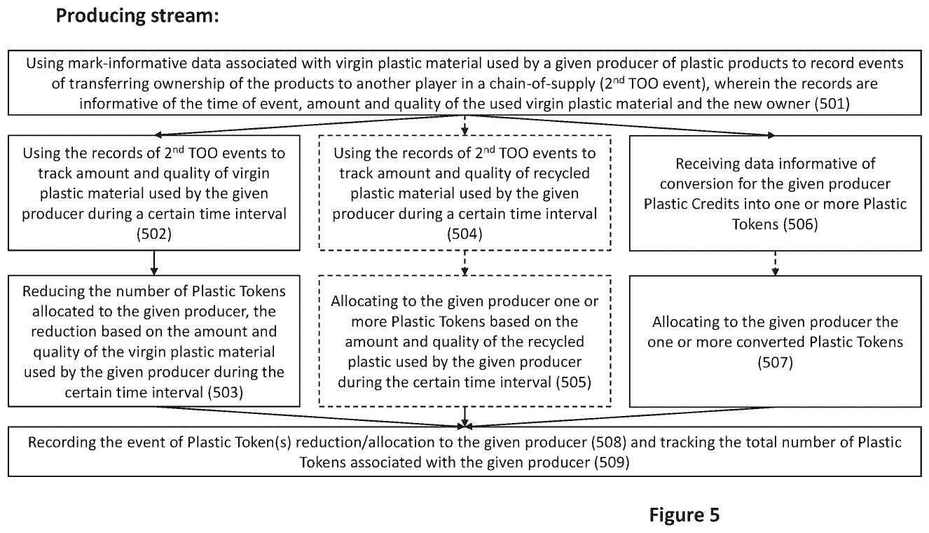

Optionally, as further detailed with reference to FIG. 5, EXP 105 can be configured to allocate Plastic Tokens for a producer for using recycled plastic materials. Allocation conversion rate in this case can differ from allocation conversion rate in operation (302).

EXP 105 tracks (306) a number of Plastic Tokens allocated to each producer.

EXP 105 enables recording (307) all Plastic Token(s) allocation/reduction events in one or more blockchains. An allocation/reduction event record is informative of a given producer/recycler, timestamp of the event and number of the currently allocated/reduced Plastic Tokens. Optionally, the record can be also informative of the amount and quality of the corresponding recycled or virgin plastic material and of a respective conversion rate.

EXP 105 further enables converting (308) the allocated Plastic Tokens into the Plastic Credits, each Plastic Credit associated with a certain recycler or producer. EXP 105 further enables (308) the registered recyclers and producers to trade the Plastic Credits. Optionally, EXP 105 can enable any player in the chain-of-supply and/or other entity registered at EXP 105 to trade the Plastic Credits.

EXP 105 enables converting the Plastic Tokens into the Plastic Credits in accordance with exchange rates. In certain embodiments the exchange rate can depend on a current trading rate of respective Plastic Credits. Alternatively or additionally, the exchange rate can depend on a quality of plastic, environmental effect, ecosystem importance, etc.

With the help of EXP 105, the registered producers can convert (309) the purchased Plastic Credits into Plastic Tokens for further use in a manufacture involving virgin plastic materials. EXP 105 enables recording the converted Plastic Tokens and updates the number of allocated Plastic Tokens associated with the respective producers.

Optionally, EXP 105 can be configured to enable at least part of the registered players to exchange Plastic Tokens “per se”, without converting them into the Plastic Credits and further trading.

EXP 105 tracks the changes of the number of Plastic Tokens allocated to each of the player

It is noted that EXP 105 can maintain two or more types of Plastic Tokens, each type of Plastic Tokens corresponding to a respective type of virgin plastic material. In such a case, the detailed above operations 304-306 can be provided separately for each type of the virgin materials.

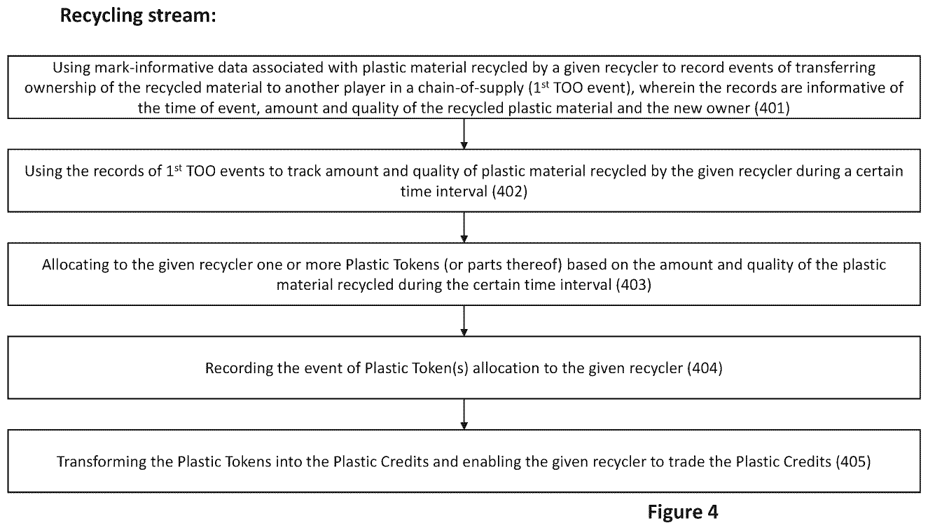

A recycling stream of the above disclosed management of the recyclable materials is further detailed by the generalized flow-chart illustrated in FIG. 4. EXP 105 uses mark-informative data associated with plastic material recycled by a given recycler to record (401) events of transferring ownership of the recycled material to another player in a chain-of-supply (referred to hereinafter as first TOO events). Each record is informative of time of respective 1^{st} TOO event, amount and quality of the recycled plastic material and of a new owner (if not decommitted).

Optionally, upon receiving by the given recycler one or more units of plastic material, EXP 105 can also use mark-informative data associated with the received units to authorize the given recycler as a current owner and to track the received plastic material until 1^{st} TOO event(s).

EXP 105 uses the records of 1^{st} TOO events to track (402) amount and quality of plastic material recycled by the given recycler during a first time interval. EXP 105 further allocates (403) to the given recycler one or more Plastic Tokens (or parts thereof) based on the amount and quality of the plastic material recycled during the first time interval and moved along the chain-of-supply. “Allocation conversion rate” is preconfigured and can depend, for example, on criteria detailed with reference to operation (302) of FIG. 3.

The first time interval can be defined by preconfigured periodicity (e.g. daily, weekly, etc.) of allocating the Plastic Tokens. Such periodicity can be configured as equal for all recyclers or can vary (e.g. depending on location of a recycler, provided recycling operations, type of plastic, expected production capacity, etc.). Alternatively or additionally, the first time interval can be defined by an amount of recycled plastic material (total amount and/or amount of a certain type of recycled plastic material) defined as triggering the allocation events.

It is noted that 1^{st} TOO events include events of transferring ownership of the recycled material from the given recycler to any player in the chain-of-supply or decommission of the recycled material.

Optionally, EXP 105 can be configured to separately track the transferring of ownership of the recycled material to different players and/or groups thereof. In such a case, EXP 105 can be configured to allocate Plastic Tokens separately and differently (e.g. with different periodicity and/or different allocation converting rate) for recycled plastic material transferred to different next owners and/or groups thereof.

EXP 105 enables recording (404) the event(s) of allocating Plastic Token(s) to the given recycler. Further, EXP 105 transforms (405) the Plastic Tokens into the Plastic Credits and enables the given recycler to trade the Plastic Credits.

FIG. 5 illustrates a producing stream of the managing the recyclable materials in accordance with certain embodiments of the presently disclosed subject matter. EXP 105 uses mark-informative data associated with virgin plastic material used by a given producer of plastic products to record (501) events of transferring ownership of the products to another player in a chain-of-supply (2^{nd} TOO event). The records are informative of the time of event, amount and quality of the used virgin plastic material and the new owner.

Optionally, upon receiving by the given producer one or more units of plastic material, EXP 105 can also use mark-informative data associated with the received units to authorize the given producer as a current owner and to track the virgin plastic material until 2^{nd} TOO event(s).

EXP 105 uses the records of 2^{nd} TOO events to track (502) amount and quality of virgin plastic material used by the given producer during a second time interval. EXP 105 further reduces (503) the number of Plastic Tokens allocated to the given producer, the reduction based on the amount and quality of the virgin plastic material used by the given producer during the second time interval in the products moved along the chain-of-supply. “Reduction conversion rate” is preconfigured and can depend, for example, on criteria detailed with reference to operation (306) of FIG. 3.

The second time interval can be defined by preconfigured periodicity (e.g. daily, weekly, etc.). Such periodicity can be configured as equal for all producers or can vary (e.g. depending on location of a producer, type of used virgin plastic, expected production capacity, the number of currently allocated Plastic Tokens, etc.). Alternatively or additionally, the second time interval can be defined by an amount of used plastic material (total amount and/or amount of a certain type of virgin plastic material) defined as triggering the reduction events. The second time interval can be equal or can differ from the first time interval.

It is noted that 2^{nd} TOO events include events of transferring ownership of the produced plastic products from the given producer to any player in the chain-of-supply.

Optionally, EXP 105 can be configured to allocate Plastic Tokens for a producer for using recycled plastic materials. EXP 105 can use the records of 2^{nd} TOO events to track (504) amount and quality of recycled plastic material used by the given producer during a third time interval. The third time interval can be equal or can differ from the second time interval. EXP 105 can further allocate (505) to the given producer one or more Plastic Tokens based on the amount and quality of the recycled plastic used by the given producer during the third time interval. All

Allocation conversion rate in this case can differ from allocation conversion rate in operation (503).

When the given producer converts one or more purchased Plastic Credits into one or more Plastic Tokens, EXP 105 receives (506) the respective data of the number of newly converted Plastic Tokens and allocates (507) to the given producer the respective number of Plastic Tokens.

EXP 105 enables recording (508) the event(s) of reduction or allocation the Plastic Token(s) to the given producer and tracking (509) the current total number of Plastic Tokens associated with the given producer.

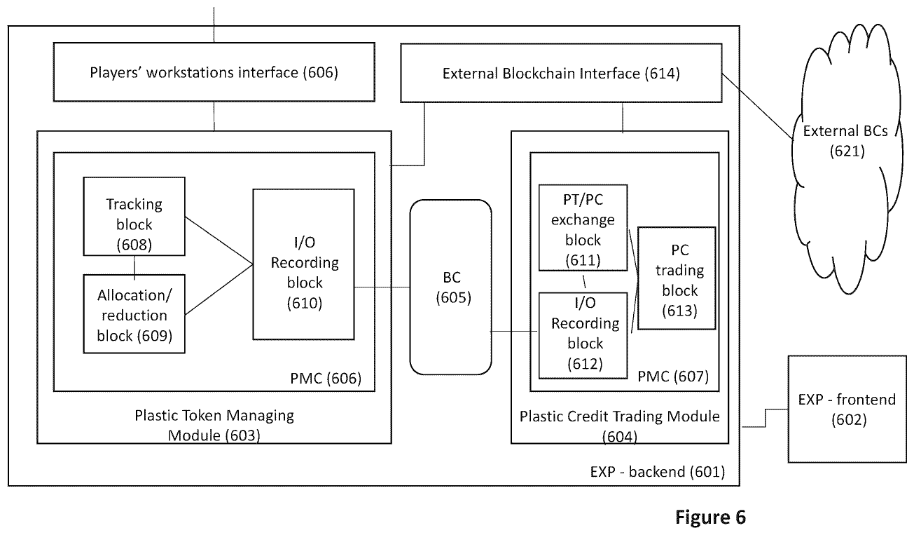

Referring to FIG. 6, there is illustrated a generalized block diagram of EXP 105 configured in accordance with certain embodiments of the presently disclosed subject matter and operating as detailed above with reference to FIGS. 1-5.

EXP 105 comprises a backend part 601 operatively connected to a frontend part 602.

EXP-frontend 602 can be configured to provide a user interface the registered players (e.g. for I/O operations and monitoring related to Plastic Tokens allocation and/or Plastic Credits trading operating).

EXP-backend 601 comprises Plastic Token (PT) management module 603 operatively connected to Plastic Credit (PC) trading module 604 and to Players' workstations (PW) interface 606. PW interface 606 is configured to enable data communication (in pull and/or push mode) between EXP 105 and the workstations associated with the players (e.g. workstations 113-1-113-3 illustrated in FIG. 1).

EXP 105 operates in data communication with one or more blockchains, some or all of the blockchains can be a part of EXP 105. In the embodiments illustrated in FIG. 6, Plastic Tokens management module 603 and Plastic Credits trading module 604 are connected therebetween by a blockchain 605 and are connected with one or more external blockchains 621 via an external blockchain interface 614.

By way of non-limiting example, EXP 105 can be configured to enable recording of data related to tracking operations on plastic material (e.g. authorization of plastic material received by a player, authorization of the old and new owners of the plastic material, etc.) in one or more external blockchains 621. External blockchains 621 can be also usable for recording data related to the trade of Plastic Credits. Optionally, different types of records can be provided in different external blockchains. External blockchain interface 614 is configured to enable data communication between the modules of EXP 105 and the external blockchain(s).

EXP 105 can be further configured to maintain records informative of TOO events and Plastic Tokens allocation/reduction events (including events of allocating Plastic Tokens converted from Plastic Credits in internal blockchain 605. Optionally, blockchain 605 can comprise separate sub-blockchains for different types of these events.

EXP 105 can be configured to record the events subject to compliance to predetermined condition indicated by a respective “smart contract”. By way of non-limiting example, in some embodiments ownership-indicative “smart contracts” can be recorded to BC 605 only upon receiving from BC(s) 621 data authorizing the old and the new owners. Likewise, allocation of Plastic Tokens converted by a given producer from Plastic Credits can be recorded in BC 605 only upon receiving from BC(s) 621 a confirmation of respective ownership of Plastic Credits.

It is noted that in other embodiments all records can be provided to a single blockchain that can be a part of EXP 105 or operatively connected thereto.

Plastic Token (PT) management module 603 comprises a processing and memory circuitry (PMC) 606, and Plastic Credit (PC) management module 604 comprises PMC 607. PMC 606 and PMC 607 are configured to execute several program components in accordance with computer-readable instructions implemented on a non-transitory computer-readable storage medium. Such executable program components are referred to hereinafter as functional blocks comprised in the PMC. The functional blocks can be implemented in any appropriate combination of software with firmware and/or hardware.

PMC 606 in PT management module 603 comprises a tracking block 608, an allocation/reduction block 609 and an I/O (Input/Output) recording block 610.

Tracking block 608 is configured to enable tracking operations detailed with reference to FIGS. 1-5. For each registered producer and recycler, tracking block 608 tracks TOO events and calculates the respective amounts of virgin and recycled plastic materials. Tracking block 608 transfers the respective data to allocation/reduction block 609 that calculates the correspondent number of Plastic Tokens to be allocated or reduced. Tracking block 608 uses the received data to track the current number of Plastic Credits allocated to the registered players.

Tracking block 608 and allocation/reduction block 609 transfer data to I/O recording block 610. I/O recording block 610 prepares the records to be recorded in blockchain 605 or 621 and send the data thereto. In turn, I/O recording block 610 is configured to request the blockchain(s) on behalf of tracking block 608 and/or allocation/reduction block 609 and to provide the requested data (e.g. authorization-related data required for TOO smart contracts) thereto.

PMC 607 in PT trading module 603 comprises a PT/PC exchange block 611, a PC trading block 613 and an I/O (Input/Output) recording block 612.

PC trading block 613 is configured to enable trading the Plastic Credits between the registered players (e.g. with the help of EXP-frontend 602) and to transfer the respective data to I/O recording block 612 for recording in the blockchain(s).

PT/PC exchange block 611 is configured to enable conversion operations detailed with reference to FIGS. 1-5 and to transfer the resulted data to I/O recording block 612 for recording in the blockchain(s).

I/O recording block 612 is further configured to request data from the respective blockchain(s) on behalf of PT/PC exchange block 611, a PC trading block 613 and to provide the requested data thereto.

It is noted that the teachings of the presently disclosed subject matter are not bound by the moderation system described with reference to FIG. 6. Equivalent and/or modified functionality can be consolidated or divided in another manner and can be implemented in any appropriate combination of software with firmware and/or hardware. Any of illustrated elements (separately and/or together) of EXP 105 can be implemented in a cloud and/or distributed and/or virtualized computing arrangement.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A method of managing units of plastic material in a cycle involving a plurality of producers and a plurality of recyclers, each given unit bearing a mark with extractable mark-informative data associated with the given unit and informative of one or more properties thereof, the method comprising:
using mark-informative data associated with the units of plastic material to track an amount and quality of plastic material recycled by each recycler of the plurality of recyclers; for each recycler, allocating one or more new Plastic Tokens in accordance, at least, with the amount of the plastic material recycled thereby and tracking a number of Plastic Tokens allocated thereto, wherein a quantity of new Plastic Tokens allocated for a certain amount of recycled plastic material is defined by a preconfigured “allocation conversion rate”;
using mark-informative data associated with the units of plastic material to track an amount of virgin plastic used by each producer of the plurality of the producers; for each producer, tracking a number of Plastic Tokens allocated thereto and reducing the number of allocated Plastic Tokens in accordance, at least, with the amount of virgin plastic material used thereby, wherein a quantity of Plastic Tokens reduced due to using a certain amount of virgin plastic material is defined by a preconfigured “reduction conversion rate”; and enabling converting the allocated Plastic Tokens into the Plastic Credits, each Plastic Credit associated with a certain recycler or producer, wherein a Plastic Token is a digital certificate representative of rights to use in production a certain amount of virgin plastic material and wherein a Plastic Credit is a Plastic Token associated with a monetized value thereof.

2. The method of claim 1, wherein the one or more new Plastic Tokens are further allocated in accordance with a quality of the plastic material recycled thereby and tracking number of Plastic Tokens allocated to each given recycler, wherein the quality can be characterized by at least one of: a type of plastic, a type of recycling operation, a number of recycling operations and previous recycling cycles.

3. The method of claim 2, wherein the allocation conversion rate is preconfigured to vary for different quality of the recycled plastic material.

4. The method of claim 1, further comprising enabling recording all events of allocating or reducing the Plastic Tokens in one or more blockchains, wherein a record of an allocating or reducing event is informative of a respective producer and/or recycler, timestamp of the event and a number of Plastic Tokens allocated or reduced in connection with the event.

5. The method of claim 1, further comprising enabling one or more recyclers from the plurality of recyclers and one or more producers from the plurality of producers to trade the Plastic Credits therebetween.

6. The method of claim 1, further comprising:
using mark-informative data associated with units of plastic material recycled by a given recycler to record events of transferring ownership of the recycled material thereby to yield one or more records of first TOO events, wherein each record is informative, at least, of time of a respective 1^{st} TOO event, amount of the recycled plastic material and of a new owner or a decommission; using the one or more records of 1^{st} TOO events to track an amount of plastic material recycled by the given recycler during a first time interval; and allocating to the given recycler one or more Plastic Tokens based on amount of the plastic material recycled during the first time interval and recording an event of allocating the one or more Plastic Tokens to the given recycler.

7. The method of claim 6, wherein the one or more records of 1^{st} TOO events are further informative of quality of respective recycled plastic material, and are further used for tracking quality of plastic material recycled by the given recycler during the first time interval and for respective allocating the one or more Plastic Tokens.

8. The method of claim 6, further comprising:
a. upon receiving by the given recycler one or more units of plastic material, using the mark-informative data associated with the received one or more units to authorize the given recycler as a current owner and to track the received one or more units of plastic material until one or more 1^{st} TOO events related thereto.

9. The method of claim 6, wherein the first time interval is defined by a preconfigured periodicity of allocating the Plastic Tokens and/or by an amount of recycled plastic material defined as triggering the allocation events.

10. The method of claim 1, further comprising:
using mark-informative data associated with one or more units of virgin plastic material used by a given producer of plastic products to record one or more events of transferring ownership of produced plastic products, thereby yield one or more records of second TOO events, wherein each record is informative, at least, of the time of event, amount of the used virgin plastic material and the new owner;
using the one or more records of 2^{nd} TOO events to track amount of virgin plastic material used by the given producer during a second time interval; and reducing the number of Plastic Tokens allocated to the given producer, the reduction based on the amount of virgin plastic material used by the given producer during the second time interval in the products with transferred ownership, and recording an event of reducing the one or more Plastic Tokens to the given producer.

11. The method of claim 10, wherein the one or more records of 2^{nd} TOO events are further informative of quality of respective virgin plastic material, and are further used for tracking quality of virgin plastic material used by the given producer during a second time interval and for respective reduction of the one or more Plastic Tokens.

12. The Method of claim 10, further comprising:
upon receiving by the given producer one or more units of virgin plastic material, using mark-informative data associated with the one or more units of virgin plastic material to authorize the given producer as a current owner and to track the virgin plastic material until one or more 2^{nd} TOO events related thereto.

13. The method of claim 10, further comprising:
using the one or more records of 2^{nd} TOO events to track amount of recycled plastic material used by the given producer during a third time interval; and allocating to the given producer one or more Plastic Tokens for using recycled plastic materials based on amount of the recycled plastic material used during the third time interval and recording an event of allocating the one or more Plastic Tokens to the given producer.

14. The method of claim 13, wherein at least two time intervals among the 1^{st} time interval, the 2^{nd} time interval and the 3rd time interval have different duration.

15. One or more computing devices comprising processors and memory, the one or more computing devices configured, via computer-executable instructions, to perform operations for operating, in a cloud computing environment, a system capable of managing units of plastic material in a cycle involving a plurality of producers and a plurality of recyclers, each given unit bearing a mark with extractable mark-informative data associated with the given unit and informative of one or more properties thereof, the operations comprising:
using mark-informative data associated with the units of plastic material to track an amount and quality of plastic material recycled by each recycler of the plurality of recyclers;
for each recycler, allocating one or more new Plastic Tokens in accordance, at least, with the amount of the plastic material recycled thereby and tracking a number of Plastic Tokens allocated thereto, wherein a quantity of new Plastic Tokens allocated for a certain amount of recycled plastic material is defined by a preconfigured “allocation conversion rate”;
using mark-informative data associated with the units of plastic material to track an amount of virgin plastic used by each producer of the plurality of the producers;
for each producer, tracking a number of Plastic Tokens allocated thereto and reducing the number of allocated Plastic Tokens in accordance, at least, with the amount of virgin plastic material used thereby, wherein a quantity of Plastic Tokens reduced due to using a certain amount of virgin plastic material is defined by a preconfigured “reduction conversion rate”; and
enabling converting the allocated Plastic Tokens into the Plastic Credits, each Plastic Credit associated with a certain recycler or producer, wherein a Plastic Token is a digital certificate representative of rights to use in production a certain amount of virgin plastic material and wherein a Plastic Credit is a Plastic Token associated with a monetized value thereof.

16. The one or more computing devices of claim 15 further configured to perform operations of claim 2.

17. A non-transitory computer-readable medium comprising instructions that, when executed by a computing system comprising a memory storing a plurality of program components executable by the computing system, cause the computing system to operate in accordance with claim 1.
